(19) United States
(12) Patent Application Publication
(10) Pub. No.: US 2017/0349326 A1
(43) Pub. Date: Dec. 7, 2017

(54) PALLET

(71) Applicant: HERUN TRADING USA COPORATION, Rochelle Park, NJ (US)

(72) Inventor: Chaoqiang Zhou, Yongkang (CN)

(73) Assignee: HERUN TRADING USA COPORATION

(21) Appl. No.: 15/470,632

(22) Filed: Mar. 27, 2017

(30) Foreign Application Priority Data
Jun. 3, 2016 (CN) 201620528739.4

(51) Int. Cl. B65D 19/00

(52) U.S. Cl. CPC B65D 19/0093; B62B 3/02

(57) ABSTRACT

A pallet comprising at least three upper carrier plates (3) and at least three carrier supports (5), in which the bottom of each upper carrier plate (3) is provided with first snapping portions (11) in an array manner, the top of each carrier support (5) is provided with first snapping grooves (4), and the upper carrier plates (3) are snapped with the first snapping grooves (4) on the top of the carrier supports (5) through the first snapping portions (11), and which reduces space occupation and facilitates storage and transportation.

### BACKGROUND OF THE INVENTION

### 1. Field of the Invention

The present application relates to a transportation tool, and in particular relates to a pallet.

### 2. Description of the Related Art

A pallet is an apparatus for packaging, stacking, carrying and transporting goods and products. Commercially-available pallets for logistics transportation at present are generally integrally molded, resulting in large space occupation and inconvenience in storage and transportation.

### SUMMARY OF THE INVENTION

Therefore, an objective of the present application is to provide a pallet that can address the defects in the art, such as large space occupation, inconvenience in storage and transportation.

A pallet in accordance with the present application comprises at least three upper carrier plates and at least three carrier supports, wherein the bottom of each upper carrier plate is provided with first snapping portions in an array manner, the top of each carrier support is provided with first snapping grooves in an array manner, and the upper carrier plates are snapped with the first snapping grooves on the top of the carrier supports through the first snapping portions.

The upper carrier plates are used for carrying articles to be transported. The carrier supports are used for supporting the upper carrier plates. The first snapping portions on the bottoms of the upper carrier plates are snapped with the first snapping grooves on the tops of the carrier supports, so that the present application can be freely disassembled and assembled conveniently. When in use, the upper carrier plates can be connected with the carrier supports only by snapping the first snapping portions and the first snapping grooves, and after the use, the upper carrier plates can be separated from the carrier supports only by separating the first snapping portions from the first snapping grooves, thereby being very convenient in assembling, disassembling, storage, and transportation.

Preferably, the above-mentioned pallet further includes at least three lower carrier plates, wherein the top of each lower carrier plate is provided with second snapping portions in an array manner, the bottom of each carrier support is provided with second snapping grooves in an array manner, and the lower carrier plates are snapped with the second snapping grooves on the bottoms of the carrier supports through the second snapping portions. The lower carrier plates can reinforce the pallet, thereby prolonging the service life of the pallet. Moreover, the lower carrier plates and the carrier supports can also be freely disassembled and assembled conveniently, thereby facilitating storage and transportation.

Preferably, the first snapping portions and the second snapping portions of the above-mentioned pallet are barbs. The design of the barbs is not only convenient for disassembling and assembling, but also resists loosening.

Preferably, end portions of the upper carrier plates and the lower carrier plates of the above-mentioned pallet are further provided with a protective casing. On one hand, the end portions of the upper carrier plates and the lower carrier plates can be protected; and on the other hand, the end portions of the upper carrier plates and the lower carrier plates can be prevented from scratching a user, thereby being safer.

Preferably, the above-mentioned pallet further includes at least three wheels and first connecting pieces, wherein the wheels are arranged at the bottom of the carrier support or the bottom of the lower carrier plate through the first connecting pieces. Therefore, the carrying process is more convenient and more labor-saving.

Preferably, the above-mentioned pallet further includes a pallet handle and a second connecting piece, wherein the pallet handle is arranged at the top of the upper carrier plate or the top of the carrier support through the second connecting piece. Therefore, the direction of the pallet is more convenient to control when objects are carried.

Preferably, the number of the wheels of the above-mentioned pallet is four. Therefore, the pallet is smoother and more stable when being used.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 is an exploded structural schematic diagram of a pallet according to an embodiment of the present application.

FIG. 2 is a structural schematic diagram of a lower carrier plate according to an embodiment of the present application.

FIG. 3 is a partial structural schematic diagram of an upper carrier plate and a carrier support at a snapping state according to an embodiment of the present application.

FIG. 4 is a partial structural schematic diagram of a lower carrier plate and the carrier support at a snapping state according to an embodiment of the present application.

FIG. 5 is a structural schematic diagram of the pallet after being disassembled according to an embodiment of the present application.

### DETAILED DESCRIPTION OF THE PRESENTLY PREFERRED EMBODIMENTS

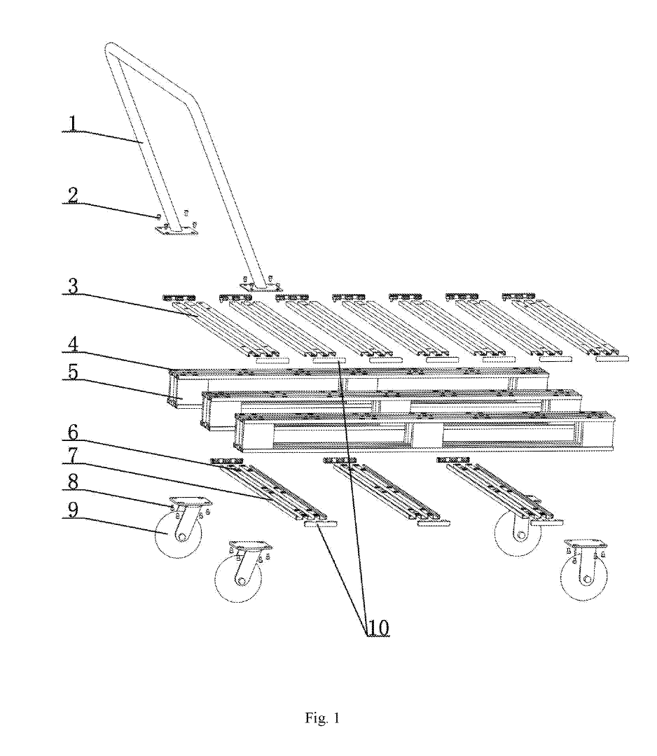

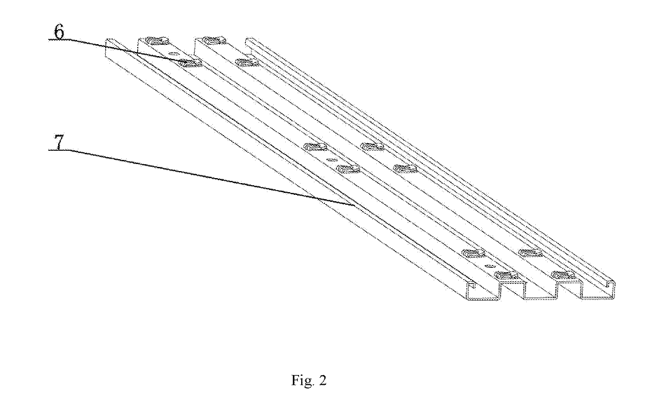

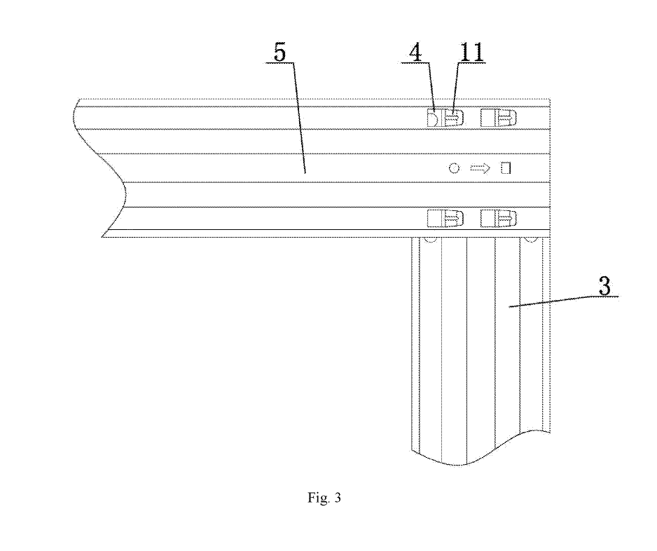

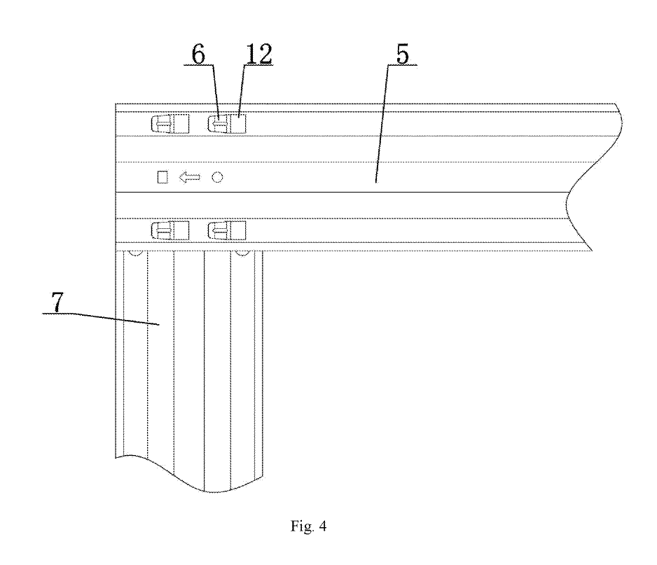

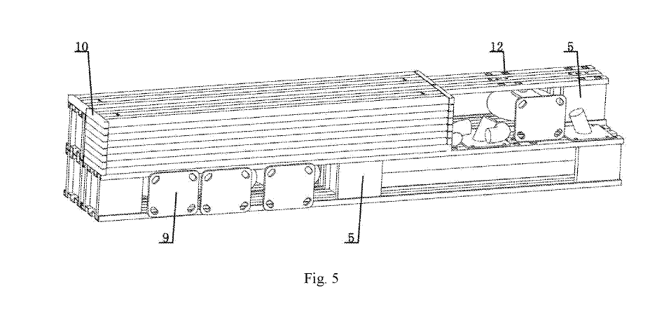

The present application is further described below in detail in combination with FIG. 1 to FIG. 5 and embodiments. The accompanying drawings and embodiments are provided to illustrate, but not to limit the present application.

As shown in FIG. 1 to FIG. 5, a pallet comprises at least three upper carrier plates 3 and at least three carrier supports 5. The bottom of each upper carrier plate 3 is provided with first snapping portions 11 in an array manner. The top of each carrier support 5 is provided with first snapping grooves 4 in an array manner. The upper carrier plates 3 are snapped with the first snapping grooves 4 on the top of the carrier supports 5 through the first snapping portions 11.

When in normal use, each upper carrier plate 3 is snapped with the carrier supports 5 one by one through the cooperation of the first snapping portions 11 and the first snapping grooves 4, then objects to be transported are placed on the upper carrier plates 3 to be transported, and the carrier supports 5 can provide a sufficient supporting force to the upper carrier plates 3 during the transportation process. After the use, when the pallet needs to be stored or transported, the first snapping portions 11 and the first snapping grooves 4 can be separated from each other, so that the upper carrier plates 3 can be disassembled from the carrier supports 5 one by one, the disassembled upper carrier plates 3 and carrier supports 5 can be stacked together, thereby greatly reducing the occupation space, being more convenient in storage and transportation, and reducing the transportation or storage cost.

Preferably, the pallet further comprises at least three lower carrier plates 7, wherein the top of each lower carrier plate 7 is provided with second snapping portions 6 in an array manner, the bottom of each carrier support is provided with second snapping grooves 12 in an array manner, and the lower carrier plates 7 are snapped with the second snapping grooves 12 on the bottoms of the carrier supports 5 through the second snapping portions 6. Similarly, when in use, the pallet can be further reinforced only by snapping the lower carrier plates 7 with the carrier supports 5 one by one, and after the use, the lower carrier plates 7 can be disassembled from the carrier supports 5 and stacked together only by separating the second snapping portions 6 from the second snapping grooves 12, thereby reducing the storage or transportation space.

Preferably, the first snapping portions 11 and the second snapping portions 6 are barbs.

Preferably, end portions of the upper carrier plates 3 and the lower carrier plates 7 are further provided with a protective casing 10.

Preferably, the pallet further includes at least three wheels 9 and first connecting pieces 8, wherein the wheels 9 are arranged at the bottom of the carrier support 5 or the bottom of the lower carrier plate 7 through the first connecting pieces 8.

Preferably, the pallet further includes a pallet handle 1 and a second connecting piece 2, wherein the pallet handle 1 is arranged at the top of the upper carrier plate 3 or the top of the carrier support 5 through the second connecting piece 2.

Preferably, the number of the wheels 9 is four.

The invention is not limited by the embodiments described above which are presented as examples only but can be modified in various ways within the scope of protection defined by the appended patent claims.

What is claimed is:

1. A pallet comprising at least three upper carrier plates and at least three carrier supports, wherein the bottom of each upper carrier plate is provided with first snapping portions in an array manner, the top of each carrier support is provided with first snapping grooves, and the upper carrier plates are snapped with the first snapping grooves on the top of the carrier supports through the first snapping portions.

2. The pallet according to claim 1, further comprising at least three lower carrier plates, wherein the top of each lower carrier plate is provided with second snapping portions in an array manner, the bottom of each carrier support is provided with second snapping grooves in an array manner, and the lower carrier plates are snapped with the second snapping grooves on the bottom of the carrier supports through the second snapping portions.

3. The pallet according to claim 2, wherein the first snapping portions and the second snapping portions are barbs.

4. The pallet according to claim 2, wherein end portions of the upper carrier plates and the lower carrier plates are further provided with a protective casing.

5. The pallet according to claim 2, further comprising at least three wheels and first connecting pieces, wherein the wheels are arranged at the bottom of the carrier support or the bottom of the lower carrier plate through the first connecting pieces.

6. The pallet according to claim 5, further comprising a pallet handle and a second connecting piece, wherein the pallet handle is arranged at the top of the upper carrier plate or the top of the carrier support through the second connecting piece.

7. The pallet according to claim 5, wherein the number of the wheels is 4.
